(19) United States
(12) Patent Application Publication
(10) Pub. No.: US 2009/0172368 A1
(43) Pub. Date: Jul. 2, 2009

(54) Hardware Based Runtime Error Detection

(75) Inventors: Victor Havin, Mountain View, CA (US); Jonathan M. Sanders, Los Gatos, CA (US)

Correspondence Address: Cuenot, Forsythe & Kim, 20283 State Road 7, Ste. 300, Boca Raton, FL, 33498, US

(73) Assignee: INTERNATIONAL BUSINESS MACHINES CORPORATION, Armonk, NY (US)

(21) Appl. No.: 11/964,684

(22) Filed: Dec. 26, 2007

(51) Int. Cl. G06F 9/30

(52) U.S. Cl. 712/227; 712/E09.016

(57) ABSTRACT

A processor that includes a storage medium which includes microcode that performs runtime analysis. The storage medium can include instrumented microcode that monitors at least one execution of a machine instruction resulting in a memory access, instrumented microcode that accesses at least one memory state indicator to determine whether the memory access is improper, and instrumented microcode that outputs an exception when the memory access is improper.

### BACKGROUND OF THE INVENTION

Runtime analysis tools are commonly used in software development to evaluate the behavior of computer programs. Runtime analysis refers to the practice of understanding computer program behavior using data that is collected during execution of a computer program under test. To implement runtime analysis, additional code is inserted into the original program in order to perform various monitoring tasks that work cooperatively with the runtime analysis tool itself. The monitoring tasks are able to detect various types of conditions that adversely affect the reliability of the computer program, for example memory leaks and memory corruption.

A memory leak is a particular kind of unintentional memory consumption by a computer program where the computer program fails to release memory when the memory is no longer needed. This condition normally is the result of an error in program code that prevents the computer program from freeing up memory that is no longer needed. Memory corruption occurs when content of a memory location are unintentionally modified due to conflicts or errors in program code. When the corrupted memory contents are later accessed by the computer program, a computer program failure, computer program performance degradation, or other improper behavior may occur.

### BRIEF SUMMARY OF THE INVENTION

The embodiments disclosed herein relate hardware based runtime error detection. One embodiment of the present invention can include a processor. The processor can include a storage medium which includes microcode that performs runtime analysis. For example, the storage medium can include instrumented microcode that monitors at least one execution of a machine instruction resulting in a memory access, instrumented microcode that accesses at least one memory state indicator to determine whether the memory access is improper, and instrumented microcode that outputs an exception when the memory access is improper.

Another embodiment of the present invention can include a method of configuring a processor to provide runtime error detection. The method can include instrumenting microcode of the processor to monitor at least one execution of a machine instruction resulting in a memory access, instrumenting the microcode of the processor to access at least one memory state indicator to determine whether the memory access is improper, and instrumenting the microcode of the processor to output an exception when the memory access is improper.

Yet another embodiment of the present invention can include a computer program product including a computer-usable medium having computer-usable program code that, when executed, causes a processor's microcode to be instrumented to perform the various steps and/or functions described herein.

### BRIEF DESCRIPTION OF THE SEVERAL VIEWS OF THE DRAWINGS

FIG. 1 is a block diagram illustrating a system for implementing hardware based runtime error detection in accordance with one embodiment of the present invention.

FIG. 2 is a flowchart illustrating a method of configuring a processor to provide runtime error detection in accordance with another embodiment of the present invention.

### DETAILED DESCRIPTION OF THE INVENTION

The present invention relates to a processor instrumented to implement hardware based runtime error detection, and a method for instrumenting the processor for such implementation. For example, microcode within the processor can be instrumented to perform the runtime error detection. Advantageously, since runtime error detection can be performed by the processor itself, applications being diagnosed for errors need not be instrumented as part of the error detection process. Thus, the hardware based runtime error detection can be implemented in a highly efficient manner.

As will be appreciated by one skilled in the art, the present invention may be embodied as a processor, a system that includes a processor, a method of configuring a processor, or a computer program product that may be executed to instrument a processor's microcode. Accordingly, the present invention may take the form of an entirely hardware embodiment, or an embodiment combining software and hardware aspects that may all generally be referred to herein as a “system.”

A computer program product in accordance with the present invention may be accessible from a computer-usable or computer-readable medium providing program code for use by, or in connection with, a processor or any instruction execution system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. For example, the medium can include, but is not limited to, an electronic, magnetic, optical, magneto-optical, electromagnetic, infrared, or semiconductor system (or apparatus or device), or a propagation medium. A non-exhaustive list of exemplary computer-readable media can include an electrical connection having one or more wires, an optical fiber, magnetic storage devices such as magnetic tape, a removable computer diskette, a portable computer diskette, a hard disk, a rigid magnetic disk, a magneto-optical disk, an optical storage medium, such as an optical disk including a compact disk-read only memory (CD-ROM), a compact disk-read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including, but not limited to, the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on a processor, partly on the processor, as a stand-alone software package, partly on the processor and partly on a remote system, or entirely on the remote system. In the latter scenario, the remote computer may be connected to the user's computer through a local area network (LAN) or a wide area network (WAN), or the connection may be made to an external computer (for example, through the Internet using an Internet Service Provider).

A system suitable for storing and/or executing program code will include at least one processor coupled directly or indirectly to memory elements through a system bus. Such processor can be a processor having microcode that is being instrumented. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor or other data processing apparatus to produce a machine, such that the instructions, which execute via the processor or other programmable data processing apparatus, create means for implementing the functions/acts specified in the flowchart and/or block diagram block or blocks.

These computer program instructions may also be stored in a computer-readable memory that can direct a processor or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a processor or other programmable data processing apparatus to cause a series of operational steps to be performed on the computer or other programmable apparatus to produce a computer implemented process such that the instructions which execute on the processor or other programmable apparatus provide steps for implementing the functions/acts specified in the flowchart and/or block diagram block or blocks.

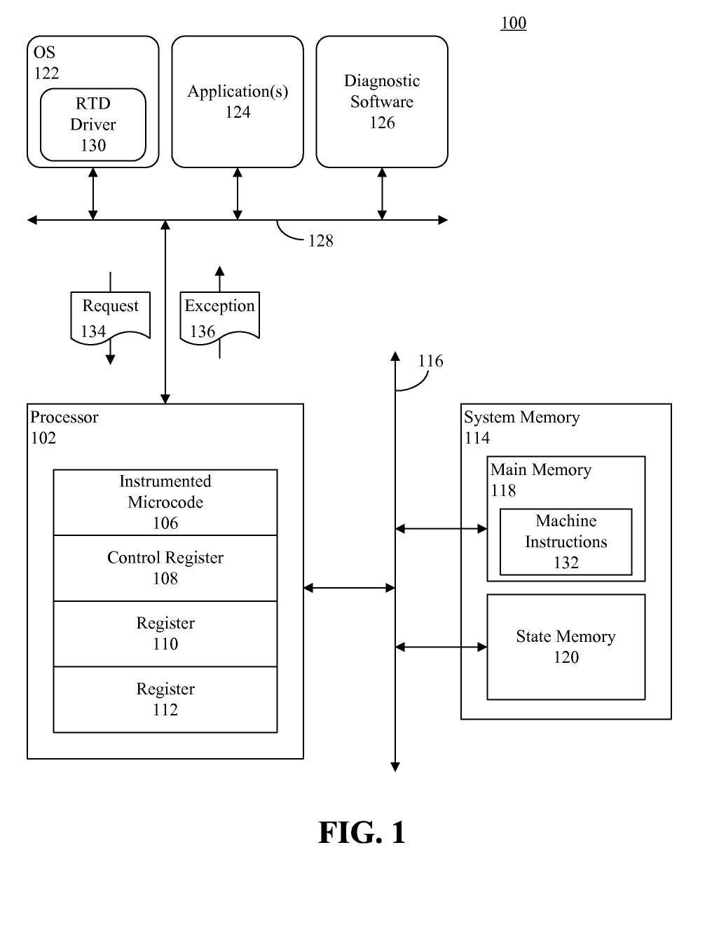

FIG. 1 is a block diagram illustrating a system 100 for implementing hardware based runtime error detection in accordance with one embodiment of the present invention. The system can include a processor 102, which can be any suitable processing system or group of processing systems. For example, the processor 102 can comprise one or more microprocessors, one or more cell processors, one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

The processor 102 can comprise one or more control stores and data registers. For example, the processor 102 can comprise a control store 106 for instrumented microcode. As used herein, the term “microcode” means a computer program or micro-program that is intrinsic to a processor and which may be executed by the processor and/or define how one or more machine instructions are rendered within the processor. As used herein, the term “instrumented microcode” means microcode that is extended, modified and/or configured to implement specific processes, such as those described herein to implement runtime error detection. Similarly, the term “instrumenting microcode” means to extend, modify and/or configure microcode to implement specific processes, such as those described herein.

The processor 102 also can include one or more registers, for example a control register 108 and a plurality of additional registers 110, 112 (e.g. EAX register, EBP register, etc.). Such registers are well known to the skilled artisan. The control register 108 can include a runtime analysis control indicator that is operable between a first state in which runtime analysis is activated within the processor 102 and a second state in which runtime analysis is not activated within the processor 102. For example, the control register 108 can comprise one or more bits which can be set to a first value to indicate runtime analysis is activated and a second value to indicate that runtime analysis is not activated.

The processor 102 can be communicatively linked to system memory 114 via a communications bus 116. The system memory 114 can include main memory 118 and state memory 120. In one arrangement, the main memory 118 and state memory 120 can be assigned to different regions of a particular set of one or more computer-usable mediums (e.g. assigned to different address ranges within one or more RAM modules). For example, the instrumented microcode 106 can reserve a range of the system memory 114 for use as the state memory 120, while one or more other memory ranges are allocated for use as the main memory 118. In another arrangement, the main memory 118 can be assigned to a first set of one or more computer-usable mediums, and the state memory 120 can be assigned to a second set of one or more computer-usable mediums. For example, the main memory 118 can be assigned to a first set of RAM modules and the state memory 120 can be assigned to a second set of RAM modules. In yet another arrangement, rather than being part of the system memory 114, the state memory 120 can be implemented elsewhere within the system 100, for example in a computer-usable medium dedicated for use as the state memory 120. Such computer-usable medium can be embedded within the processor 102, or provided as a separate component.

The processor 102 also can be communicatively linked to an operating system 122, one or more applications 124 and diagnostic software 126 via a communications bus 128. For example, the communications bus 128 can communicatively link the processor 102 to one or more computer-usable mediums, such as those previously described, on which the operating system 122, application(s) 124 and diagnostic software 126 are stored. For instance, the operating system 122, application(s) 124 and diagnostic software 126 can be stored to one or more computer-usable mediums that may include, but are not limited to, electronic, magnetic, optical, magneto-optical, electromagnetic, infrared, or semiconductor systems, or propagation mediums. By way of example, the system memory 114 can be provided on one or more sets of RAM modules and the operating system 122, application(s) 124 and diagnostic software 126 can be provided on a magnetic storage medium. Nonetheless, the invention is not limited to this example and any other suitable computer-usable mediums can be used.

A runtime diagnostic driver 130 can be installed within the operating system 122. The runtime diagnostic driver 130 can be an extension of the operation system 122 that is capable of intercepting operations of the operating system 122 that cause changes in program memory layout. Examples of such operations include, but are not limited to, memory allocation, memory de-allocation, memory relocation, protection mode changes, and the like. Information pertaining to the intercepted operations may be stored in the system memory 114 in such a manner that it can be shared with the instrumented microcode 106 and diagnostic software 126 that may be provided to analyze such information. For example, the information can be stored in the main memory 118 and/or the state memory 120. The information may be accessed by the operating system 122, the runtime diagnostic driver 130 and/or the diagnostic software 126 by generating a request 134. The information also can be shared between the instrumented microcode 106 and the operating system 122, runtime diagnostic driver 130, and/or diagnostic software 126 using a shared memory region of the system memory 114.

Hereinafter the operating system 122 and applications 124 will be collectively referred to as software 122, 124. The main memory 118 can be accessed by the processor 102 while executing the software 122, 124. As used herein, to “access” memory means to allocate memory, to de-allocate memory, to write data to the memory, to read data written to the memory, and/or to set, update or modify data written to the memory. The state memory 120 also can be accessed by the processor 102 while executing the software 122, 124 when the runtime analysis is activated within the processor 102. In particular, the processor 102 can store to the state memory 120 memory state information corresponding to the state of the main memory 118 during execution of the software 122, 124. Such memory state information can comprise a plurality of memory state indicators, each of which corresponds to a particular block of the main memory 118. For example, each memory state indicator can comprise two bits of data and can correspond to a particular byte of data in the main memory.

In operation, the runtime analysis control indicator within the control register 108 can be set to a particular value to indicate whether it is desired for runtime error detection to be implemented by the processor 102. When the runtime analysis control indicator is set to a value that indicates that runtime error detection is not to be implemented, the instrumented microcode 106 can be executed in a conventional manner in which the state memory 120 is not used to track accesses to the main memory 118.

When the runtime analysis control indicator is set to a value that indicates that runtime error detection is to be implemented, however, the processor 102 can execute the instrumented microcode 106 so as to monitor execution of machine instructions 132 resulting in accesses to the main memory 118, for example while the software 122, 124 is being executed by the processor 102. In addition, the processor 102 can activate the runtime diagnostic driver 130 to monitor memory allocations and de-allocations performed by the operating system 122. Further, the instrumented microcode 106 can access the state memory 120 to read/write memory state indicators that track accesses to the main memory 118 performed by the machine instructions 132 and/or the operating system 122. For instance, within the state memory 120 the instrumented microcode 106 can store memory state indicators that identify bytes within the main memory 118 that are unallocated, bytes that are allocated but uninitialized, bytes that are allocated and initialized, and bytes that are trapped. As used herein, memory that is “trapped” is memory that is allocated for special use. For example, trapped memory can be memory that is used to trigger a debugger breakpoint. The debugger breakpoint can be triggered, for instance, when a trapped memory address is referenced. In another example, trap bits can be stored in the trapped memory to mark memory that was released by an application 124, but is still mapped into the application memory space, and hence still may be accessed by the application 124.

The instrumented microcode 106 also can monitor access to the main memory 118, along with the states of various locations being accessed as indicated by the state memory 120, to determine when the accesses to the main memory 118 may potentially adversely affect the reliability of the software 122, 124. For example, the memory access can be monitored to detect potential memory leaks within the main memory 118 or other conditions that may corrupt the main memory 118. Such other conditions can include, but are not limited to, uninitialized memory reads (UMRs), array boundary overruns, (e.g. array boundary reads (ABRs) and array boundary writes (ABWs)), and invalid memory access (e.g. invalid memory reads (IMRs) and invalid memory writes (IMWs)). As known to the skilled artisan, a UMR is a read from a memory location that is uninitialized. Array boundary overruns are array boundary violations during reads/writes. An IMR is a read from a memory location that is unallocated and an IMW is a write to a memory location that is unallocated. Still, other memory conditions which may corrupt the main memory 118 are known in the art, and detection of such memory conditions are within the scope of the present invention.

When accesses to the main memory 118 are detected that are improper, for instance they may potentially adversely affect the reliability of the software 122, 124, the instrumented microcode 106 can generate an exception (or interrupt) 136 and output such exception 136. As used herein, to output the exception 136 can include, but is not limited to, storing the exception in memory (e.g. writing to a file, writing to a user display or other output device), communicating the exception 136 to the operating system 122, communicating the exception 136 to the runtime diagnostic driver(s) 130, communicating the exception 136 to the application(s) 124, communicating the exception 136 to another system, exporting the exception 136, or the like. For example, the exception 136 can be communicated to the runtime diagnostic driver(s) 130, which can present the exception via a user interface or process the exception in another suitable manner.

As an example, consider the following machine instruction:

MOV [EBP], EAX

Such instruction can be implemented to move content of an EAX register (e.g. the register 110) to the main memory 118. The address of the location in the main memory 118 to which the content is moved can be identified by an address contained in an EBP register (e.g. the register 112). A typical microcode implementation of this instruction can be rendered in the following sequence:
Fetch data from the EAX register
Fetch an address for a memory location from the EBP register
Activate the fetched memory address on the system bus
Initiate a send data to address operation
Wait for the bus operation to complete
   The above sequence can be implemented by the instrumented microcode 106 when the runtime analysis control indicator in the control register 108 indicates that runtime error detection is not to be performed. However, when the runtime analysis control indicator indicates that runtime error detection is to be performed, the instrumented microcode 106 can be implemented to render the instruction in the following sequence:
Fetch data from the EAX register
Fetch an address for a memory location from the EBP register
Fetch memory state indicators for the memory address
If the memory state indicators indicate that the memory address is unallocated or trapped, then output an IMW exception (e.g. invalid memory write)
If the memory state indicators indicate that the memory address is allocated but uninitialized, then set (or update) the memory state indicators to indicate that the memory address is now allocated and initialized (e.g. that the memory address is ready to be used)
Activate the fetched memory address on the system bus
Initiate send data to address operation
Wait for the bus operation to complete

It should be noted that the above example represents one embodiment of how the microcode 106 can be instrumented to track memory accesses performed by a particular machine instruction 132 in order to implement hardware based runtime error detection, but the microcode 106 can be instrumented to track any number of machine instructions 132 and such tracking can be implemented in any suitable manner.

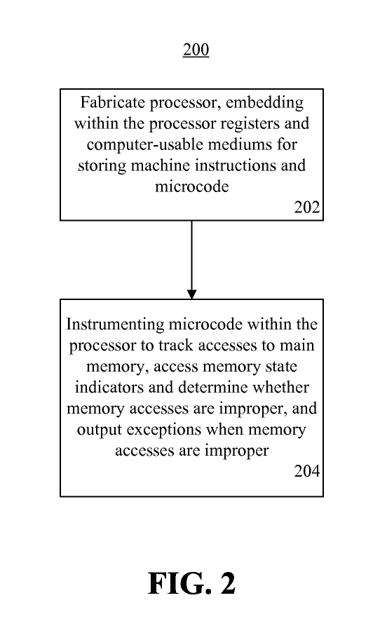

FIG. 2 is a flowchart illustrating a method 200 of configuring a processor to provide runtime error detection in accordance with another embodiment of the present invention. At step 202, a processor can be fabricated using techniques known to the skilled artisan. During such processing, a plurality of registers can be embedded within the processor. At least one of the registers embedded within the processor can be a control register. The control register can comprise a runtime analysis control indicator that is operable between a first state in which runtime analysis is activated within the processor and a second state in which runtime analysis is not activated within the processor. One or more computer-usable mediums for storing machine instructions and microcode also can be embedded within the processor. As used herein, to embed within a processor means to incorporate as a part or characteristic of the processor

At step 204, microcode within the processor can be instrumented to track accesses to main memory, access memory state indicators to determine whether memory accesses are improper, and output exceptions when memory accesses are improper. To instrument the microcode to provide runtime error detection, a computer-usable medium comprising computer-usable program code can be provided. The computer-usable program code can be accessed and loaded into a suitable control register of the processor during the processor's fabrication. For example, a utility application that is configured for loading microcode into processors can be executed to load the microcode into the control register. Such utility applications are known to the skilled artisan.

The flowchart(s) and block diagram(s) in the figures illustrate the architecture, functionality, and operation of possible implementations of systems, methods and computer program products according to various embodiments of the present invention. In this regard, each block in the flowchart(s) or block diagram(s) may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagram(s) and/or flowchart illustration(s), and combinations of blocks in the block diagram(s) and/or flowchart illustration(s), can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. A processor, comprising:
a storage medium comprising microcode that performs runtime analysis, the storage medium comprising:
instrumented microcode that monitors at least one execution of a machine instruction resulting in a memory access;
instrumented microcode that accesses at least one memory state indicator to determine whether the memory access is improper; and
instrumented microcode that outputs an exception when the memory access is improper.

2. The processor of claim 1, wherein the storage medium further comprises:
instrumented microcode that communicates the exception to a runtime diagnostic driver.

3. The processor of claim 1, wherein:
the instrumented microcode that accesses at least one memory state indicator to determine whether the memory access is improper comprises:
instrumented microcode that fetches data from a first register;
instrumented microcode that fetches a memory address from a second register; and
instrumented microcode that fetches the memory state indicator from a location in a state memory that corresponds to the memory address; and
the instrumented microcode that outputs an exception comprises:
instrumented microcode that selectively generates the exception when the memory state indicator indicates that the memory address is unallocated or trapped.

4. The processor of claim 1, wherein:
the instrumented microcode that accesses at least one memory state indicator to determine whether the memory access is improper comprises:
instrumented microcode that fetches data from a first register;
instrumented microcode that fetches a memory address from a second register; and
instrumented microcode that fetches the memory state indicator from a location in a state memory that corresponds to the memory address; and
the storage medium further comprises:
instrumented microcode that selectively changes the memory state indicator if the memory state indicator indicates that the memory address is allocated but uninitialized.

5. The processor of claim 4, wherein the instrumented microcode that selectively changes the memory state indicator comprises:
instrumented microcode that changes the memory state indicator to indicate that the memory address is allocated and initialized.

6. The processor of claim 1, wherein the storage medium further comprises:
instrumented microcode that reserves a range of system memory for use as a state memory in which the at least one memory state indicator is stored.

7. The processor of claim 1, further comprising:
a control register that comprises a runtime analysis control indicator that is operable between a first state in which runtime analysis is activated within the processor and a second state in which runtime analysis is not activated within the processor.

8. A method of configuring a processor to provide runtime error detection, comprising:
instrumenting microcode of the processor to monitor at least one execution of a machine instruction resulting in a memory access;
instrumenting the microcode of the processor to access at least one memory state indicator to determine whether the memory access is improper; and
instrumenting the microcode of the processor to output an exception when the memory access is improper.

9. The method of claim 8, wherein further comprising instrumenting the microcode of the processor to communicate the exception to a runtime diagnostic driver.

10. The method of claim 8, further comprising:
instrumenting the microcode of the processor to fetch data from a first register;
instrumenting the microcode of the processor to fetch a memory address from a second register;
instrumenting the microcode of the processor to fetch the memory state indicator from a location in a state memory that corresponds to the memory address; and
instrumenting microcode of the processor to selectively generate the exception when the memory state indicator indicates that the memory address is unallocated or trapped.

11. The method of claim 8, further comprising:
instrumenting the microcode of the processor to fetch data from a first register;
instrumenting the microcode of the processor to fetch a memory address from a second register;
instrumenting the microcode of the processor to fetch the memory state indicator from a location in a state memory that corresponds to the memory address; and
instrumenting microcode of the processor to selectively change the memory state indicator if the memory state indicator indicates that the memory address is allocated but uninitialized.

12. The method of claim 11, further comprising:
instrumenting microcode of the processor to selectively change the memory state indicator to indicate that the memory address is allocated and initialized.

13. The method of claim 8, further comprising:
instrumenting microcode of the processor to reserve a range of system memory for use as a state memory in which the at least one memory state indicator is stored.

14. The method of claim 8, further comprising:
embedding within the processor a control register that comprises a runtime analysis control indicator that is operable between a first state in which runtime analysis is activated within the processor and a second state in which runtime analysis is not activated within the processor.

15. A computer program product comprising:
a computer-usable medium comprising computer-usable program code that configures a processor to provide runtime error detection, the computer-usable medium comprising:
computer-usable program code that configures the processor to monitor at least one execution of a machine instruction resulting in a memory access;
computer-usable program code that configures the processor to access at least one memory state indicator to determine whether the memory access is improper; and
computer-usable program code that configures the processor to output an exception when the memory access is improper.

16. The computer program product of claim 15, wherein the computer-usable medium further comprises computer-usable program code that configures the processor to communicate the exception to a runtime diagnostic driver.

17. The computer program product of claim 15, wherein:
the computer-usable program code that configures the processor to access at least one memory state indicator to determine whether the memory access is improper comprises:
computer-usable program code that configures the processor to fetch data from a first register;
computer-usable program code that configures the processor to fetch a memory address from a second register; and
computer-usable program code that configures the processor to fetch the memory state indicator from a location in a state memory that corresponds to the memory address; and
the computer-usable program code that configures the processor to output an exception comprises:
computer-usable program code that configures the processor to selectively generate the exception when the memory state indicator indicates that the memory address is unallocated or trapped.

18. The computer program product of claim 15, wherein:
the computer-usable program code that configures the processor to access at least one memory state indicator to determine whether the memory access is improper comprises:
computer-usable program code that configures the processor to fetch data from a first register;
computer-usable program code that configures the processor to fetch a memory address from a second register;
computer-usable program code that configures the processor to fetch the memory state indicator from a location in a state memory that corresponds to the memory address; and
the computer-usable medium further comprises:
computer-usable program code that configures the processor to selectively change the memory state indicator if the memory state indicator indicates that the memory address is allocated but uninitialized.

19. The computer program product of claim 18, wherein the instrumented microcode that selectively changes the memory state indicator comprises:
computer-usable program code that configures the processor to change the memory state indicator to indicate that the memory address is allocated and initialized.

20. The computer program product of claim 15, wherein the computer-usable medium further comprises:
computer-usable program code that configures the processor to reserve a range of system memory for use as a state memory in which the at least one memory state indicator is stored.
